(19) United States
(12) Patent Application Publication
(10) Pub. No.: US 2026/0134723 A1
(43) Pub. Date: May 14, 2026

(54) PARKED VEHICLE COLLISION DETECTION SYSTEM

(71) Applicant: State Farm Mutual Automobile Insurance Company, Bloomington, IL (US)

(72) Inventors: Michael A. Best, Mesa, AZ (US); Chad Brandon Witt, Bloomington, IL (US)

(73) Assignee: State Farm Mutual Automobile Insurance Company, Bloomington, IL (US)

(21) Appl. No.: 18/945,233

(22) Filed: Nov. 12, 2024

(51) Int. Cl. G07C 5/00; G07C 5/08

(52) U.S. Cl. CPC G07C 5/008; G07C 5/0808

(57) ABSTRACT

A system may include one or more processors and one or more non-transitory, computer-readable media including instructions which, when executed by the one or more processors, cause the one or more processors to obtain sensor data including accelerometer data captured by one or more sensors associated with a vehicle, execute a machine-learning model using as input the sensor data to determine a condition of a plurality of predefined conditions, and in response to the determined condition including an impact to the vehicle while the vehicle was parked, transmit an alert to a computing device regarding the impact to the vehicle.

### TECHNICAL FIELD

The present disclosure generally relates to vehicle collision detection. More particularly, the present systems and methods relate to detecting vehicle collisions including parked vehicles.

### BACKGROUND

Collisions that occur when vehicles are parked and when drivers are away from their vehicles may not be immediately detected by the drivers, complicating efforts to identity damage to the vehicles and determine a source of the damage. It would be advantageous to have a system for detecting and alerting drivers to such collisions.

### BRIEF SUMMARY

Aspects of the present disclosure are directed to a system, including one or more processors, and one or more non-transitory, computer-readable media including instructions which, when executed by the one or more processors, cause the one or more processors to obtain sensor data including accelerometer data captured by one or more sensors associated with a vehicle, execute a machine-learning model using as input the sensor data to determine a condition of a plurality of predefined conditions, and in response to the determined condition including an impact to the vehicle while the vehicle was parked, transmit an alert to a computing device regarding the impact to the vehicle.

In some implementations, the system includes a housing enclosing the one or more sensors, the one or more processors, and the one or more non-transitory, computer-readable media, wherein the housing is separate from and coupled to the vehicle. In some implementations, the instructions cause the one or more processors to determine, using the sensor data, that the sensor data exceeds one or more predefined thresholds, and in response to the sensor data exceeding the one or more predefined thresholds, executing the machine-learning model using as input the sensor data. In some implementations, the computing device includes a mobile device, and wherein the alert triggers a notification to inspect a status of the vehicle. In some implementations, the instructions cause the one or more processors to obtain the sensor data from a sensor device coupled to the vehicle. In some implementations, the instructions cause the one or more processors to generate a notification to document a condition of the vehicle. In some implementations, the instructions cause the one or more processors to correlate the sensor data with geolocation data. In some implementations, the instructions cause the one or more processors to execute the machine-learning model using as input the sensor data to determine a location of the impact to the vehicle. In some implementations, the computing device executes a second machine-learning model to determine a second condition of the plurality of predefined conditions. In some implementations, the alert includes a request to store camera data. In some implementations, the computing device includes a camera coupled to the vehicle.

Aspects of the present disclosure are directed to one or more non-transitory, computer-readable media including instructions which, when executed by one or more processors, cause the one or more processors to obtain time series acceleration data of one or more vehicles, the time series acceleration data captured when the one or more vehicles were parked, wherein the time series acceleration data is labeled with labels indicating whether an impact occurred, execute a machine-learning model using as input the time series acceleration data to determine whether an impact occurred, and update the machine-learning model based on the labels to reduce a loss between impact determinations generated by the machine-learning model and actual impacts indicated by the labels.

In some implementations, the instructions cause the one or more processors to obtain the time series acceleration data of each of the one or more vehicles from a sensor device that is separate from and coupled to the vehicle. In some implementations, the time series acceleration data includes historical time series acceleration data, and wherein the labels include user input regarding impacts. In some implementations, the time series acceleration data includes a geolocation of the one or more vehicles. In some implementations, the labels indicate a location of impact on the vehicle, and where the instructions cause the one or more processors to update the machine-learning model based on the labels to reduce a loss between impact location determinations generated by the machine-learning model and actual impact locations indicated by the labels. In some implementations, the instructions cause the one or more processors to update a preliminary machine-learning model based on the labels to reduce a loss between impact determinations generated by the preliminary machine-learning model and actual impacts indicated by the labels, wherein the preliminary machine-learning model has a lower level of accuracy than the machine-learning model, and wherein the preliminary machine-learning model has a lower computational burden than the machine-learning model.

Aspects of the present disclosure are directed to a method, including determining, using data from one or more sensors of a sensor device separate from and coupled to a vehicle, that the vehicle is parked, obtaining, using the one or more sensors, time series acceleration data while the vehicle is parked, in response to the time series acceleration data including one or more parameters above a predetermined threshold, transmitting the time series acceleration data from the sensor device to a mobile device, receiving, at a second device, the time series sensor data, executing, using one or more processors of the second device, a machine-learning model to determine a vehicle condition of the vehicle from a plurality of predefined vehicle conditions, the machine-learning model trained to reduce a loss between impact determinations generated by the machine-learning model executed using as input time series data and actual impacts associated with the time series data, and in response to the determined vehicle condition being an impact to the vehicle while parked, transmitting, using the one or more processors of the second device, an alert to a mobile device regarding the impact to the vehicle.

In some implementations, the method includes executing, at the mobile device, a preliminary machine-learning model to determine a preliminary vehicle condition from a plurality of preliminary vehicle conditions. In some implementations, the method includes, in response to the determined vehicle condition being an impact to the vehicle while parked, transmitting a request to an additional sensor device of the vehicle to store additional sensor data.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

FIG. 1 illustrates an example environment for parked vehicle collision detection.

FIG. 2 illustrates details of the sensor device of FIG. 1.

FIG. 3 is a flow chart illustrating operations of an example method for detecting parked vehicle collisions.

FIG. 4 is a flow chart illustrating operations of an example method for detecting parked vehicle collisions.

FIG. 5 is a flow chart illustrating operations of an example method for detecting parked vehicle collisions.

The Figures depict preferred embodiments for purposes of illustration only. One skilled in the art will readily recognize from the following discussion that alternative embodiments of the systems and methods illustrated herein may be employed without departing from the principles of the present embodiments described herein.

### DETAILED DESCRIPTION

Embodiments and implementations discussed herein relate to systems and methods for detecting parked vehicle collisions. Conventional systems for detecting collisions rely upon integrated vehicle sensors that drain vehicle batteries and which represent a significant cost, preventing their use in many vehicles. Additionally, some such systems may only detect collisions while the vehicle is moving and/or activated. Some vehicles are equipped with sensors to monitor a proximity to the vehicle, but these sensors drain power from the vehicle and add significant cost to the vehicle. Embodiments and implementations described herein provide for parked vehicle collision detection using a sensor device that can be attached to any vehicle, and which uses low-power processes that allow the sensor device to draw power from its own battery. Thus, according to some implementations of the present disclosure, parked vehicle collisions can be detected without integrated vehicle sensors and without draining power from the vehicle battery.

In some embodiments, the sensor device can be attached to a vehicle and can capture acceleration data of the vehicle. The sensor device can transmit the acceleration data to a mobile device. The mobile device can transmit the acceleration data to an analytic server for analysis and/or analyze the acceleration data of the vehicle. In some implementations, when the vehicle is parked and the mobile device disconnects from the sensor device (e.g., the mobile device moves out of range of the sensor device), the sensor device can monitor the acceleration data to determine whether the acceleration data exceeds a predetermined threshold. The acceleration data exceeding a predetermined threshold can indicate a collision with the parked vehicle. In some embodiments, the sensor device can log the acceleration data to deliver to the mobile device. Once the sensor device is reconnected with the mobile device (e.g., the mobile device comes into the range of the sensor device and reconnects), the sensor device can transmit the logged acceleration data to the mobile device to inform the mobile device of the collision. In this way, the sensor device is able to detect the collision to the parked vehicle without the use of integrated vehicle sensors and without drawing power from the battery of the vehicle.

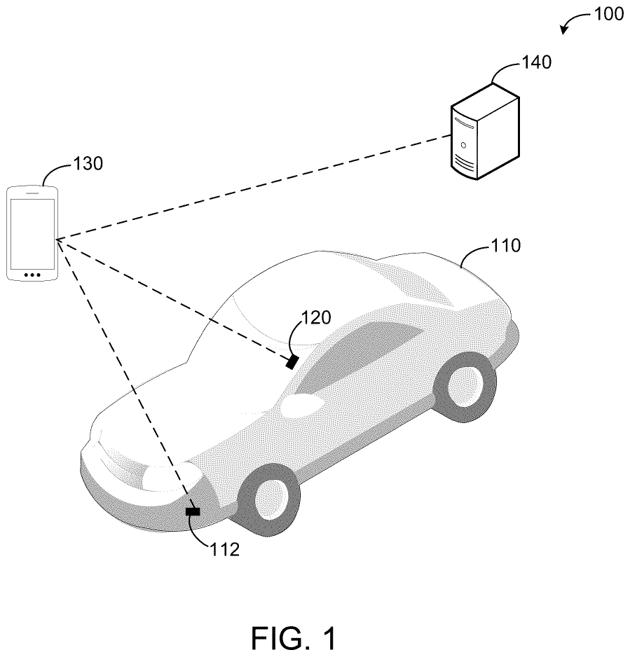

FIG. 1 illustrates an example environment 100 for parked vehicle collision detection. The environment 100 includes a vehicle 110, a sensor device 120, a mobile device 130, and a server 140. The vehicle 110 can include a vehicle sensor 112. The sensor device 120, the mobile device 130, and the server 140 (and in some cases the vehicle sensor 112) can communicate to detect collisions to the vehicle 110 when the vehicle is parked.

The sensor device 120 includes one or more sensors that capture sensor data (e.g., time series sensor data), including acceleration data. The sensor device 120 can include one or more accelerometers to capture acceleration data in three dimensions. The sensor device 120 can be coupled to the vehicle 110. In an example, the sensor device 120 is coupled to an interior surface of a windshield of the vehicle 110.

The sensor device 120 can capture sensor data (e.g., acceleration data) and transmit the sensor data to the mobile device 130 via a first network protocol, such as Bluetooth. In some implementations, the vehicle sensor 112 sends sensor data to the mobile device 130 via the first network protocol, or another network protocol. The mobile device 130 can transmit the sensor data to the server 140 via a second network protocol, such as a cellular network protocol, or the Internet. The server 140 can analyze the sensor data to determine characteristics of the sensor data. In some implementations, the server 140 determines events in the sensor data. In some implementations, the server 140 determines conditions in the sensor data corresponding to a plurality of predefined conditions. The server 140 can determine the conditions based on determined events in the sensor data. The server 140 can map events in the sensor data to the plurality of predefined conditions. In an example, the server 140 can determine an event in the sensor data that indicates that the vehicle came to a stop with a deceleration above a predetermined threshold, corresponding to a “hard stop” condition. In an example, the server 140 can determine an event in the sensor data that indicates that the vehicle accelerated from a stop with an acceleration above a predetermined threshold, corresponding to a “fast start” condition. In an example, the server 140 can determine an event in the sensor data that indicates that the vehicle experience lateral movement above a predetermined threshold, corresponding to a “swerving” condition.

The server 140 can execute one or more machine-learning models to determine the events and corresponding conditions in the sensor data. In some implementations, the server 140 executes a machine-learning model using as input the sensor data to determine the events in the sensor data and the corresponding conditions. The machine-learning model can be any type of machine-learning model such as a neural network, a convolutional neural network (CNN), a recurrent neural network (RNN), a transformer network, a support vector machine, a decision tree, an ensemble tree, a generalized additive model (GAM), a naïve Bayes classifier, a k-Nearest neighbor (KNN) classifier, a discriminant analysis classifier, or any other type of machine-learning model. In some implementations, the server 140 executes a first machine-learning model to determine a second machine-learning model to determine events in the sensor data. In an example, the server 140 executes a CNN to determine features of the sensor data and identify a transformer network based on the features of the sensor data to determine events in the sensor data.

In some implementations, the sensor device 120 analyzes the sensor data to determine one or more first preliminary characteristics of the sensor data and transmits the sensor data and the one or more first preliminary characteristics to the mobile device 130. In an example, the sensor device 120 executes a sensor device machine-learning model using as input the sensor data to generate the one or more first preliminary characteristics of the sensor data. In some implementations, the mobile device 130 analyzes the sensor data and/or the one or more preliminary characteristics to determine one or more second preliminary characteristics of the sensor data and transmits the sensor data and the one or more second preliminary characteristics to the server 140. In an example, the mobile device 130 executes a mobile device machine-learning model using as input the sensor data to generate the one or more second preliminary characteristics. In an example, the mobile device 130 executes the mobile device machine-learning model using as input the sensor data and the one or more first preliminary characteristics to generate the one or more second preliminary characteristics. In an example, the mobile device 130 executes the mobile device machine-learning model using as input the one or more first preliminary characteristics to generate the one or more second preliminary characteristics. In this way, the sensor device 120 and/or the mobile device 130 can determine preliminary characteristics of the sensor data. The server 140 can use the determined preliminary characteristics in determining the events in the sensor data.

When the vehicle 110 is parked and a user carrying the mobile device 130 exits the vehicle 110 and moves outside of a range of the sensor device 120, the sensor device 120 loses its connection with the mobile device 130. In an example, the sensor device 120 loses a Bluetooth connection with the mobile device 130. The sensor device 120 can determine that the vehicle is parked based on the sensor data and/or the loss of connection with the mobile device 130. In an example, the sensor device 120 determines that the vehicle is stopped based on acceleration data captured by the sensor device 120 and determines that the vehicle is parked based on a combination of the vehicle being stopped and a loss of connection with the mobile device 130 that exceeds a predetermined interval. In response to determining that the vehicle is parked, the sensor device 120 can enter a sleep mode.

In the sleep mode, the sensor device 120 executes a lower-energy process that captures acceleration data and compares the acceleration data to one or more predetermined thresholds. The lower-energy process can consume less energy than higher-energy processes executed by the sensor device 120 when not in the sleep mode, such as when the sensor device 120 is capturing sensor data, transmitting sensor data to the mobile device 130, and/or analyzing the sensor data. In an example, the lower-energy process compares X-axis acceleration data to an X-axis acceleration threshold, Y-axis acceleration data to a Y-axis acceleration threshold, and Z-axis acceleration data to a Z-axis acceleration threshold. In some implementations, the X-axis acceleration threshold, the Y-axis acceleration threshold, and the Z-axis acceleration threshold are all different thresholds, representing different indications of collision along the different axes. The one or more predetermined thresholds can represent expected acceleration corresponding to a collision. The one or more predetermined thresholds can be high enough to avoid false positives, such as motion of the vehicle 110 due to wind, traffic, or loud noises. In some implementations, the sensor device 120, in the sleep mode, executes a machine-learning model that is trained to receive as input acceleration data and output determinations of collisions.

In response to the acceleration data exceeding the one or more predetermine thresholds, the sensor device 120 exits the sleep mode and starts higher-energy processes to log, and/or analyze the sensor data. In some implementations, the sensor device 120 logs the acceleration data in response to exiting the sleep mode. In an example, the sensor device 120 holds five seconds of acceleration data in a rolling buffer in the sleep mode and stores the five seconds of acceleration data located in the rolling buffer in a memory of the sensor device 120 in response to exiting the sleep mode. In this way, the sensor device 120 can log acceleration data that was captured while the sensor device 120 was in the sleep mode, even if the sensor device 120 does not log all acceleration data captured during the sleep mode. In some implementations, the sensor device 120 analyzes the acceleration data that cause the sensor device 120 to exit the sleep mode to determine whether the acceleration data indicates a collision occurred. In some implementations, the sensor device 120 executes a machine-learning model using as input the acceleration data in response to the acceleration data exceeding the one or more predetermined thresholds to determine events in the acceleration data. In an example, the sensor device 120, in response to exiting the sleep mode due to the acceleration data exceeding the one or more predetermined thresholds, executes the machine-learning model to determine whether the acceleration data indicates a collision.

In some implementations, the sensor device 120 transmits an alert regarding the collision to the vehicle sensor 112. The alert may cause the vehicle sensor 112 to record data. In an example, the vehicle sensor 112 includes a camera and the alert causes the camera to record and/or store image and/or video data. In some implementations, the sensor device 120 transmits an alert regarding the collision to a dashcam or other recording device coupled to the vehicle 110. In an example, the sensor device 120 sends the alert to cause the dashcam to record and/or store video data.

In response to reconnecting with the mobile device 130, the sensor device 120 transmits an indication of the exit from sleep mode to the mobile device 130. In some implementations, the indication includes a message that while the vehicle was parked, the sensor device 120 exited sleep mode due to acceleration data. In some implementations, the indication includes a message that while the vehicle was parked, the sensor device 120 exited sleep mode due to acceleration data and the acceleration data that cause the sensor device 120 to exit the sleep mode. In some implementations, the indication includes a message that while the vehicle was parked, the sensor device 120 exited sleep mode due to acceleration data, the acceleration data that cause the sensor device 120 to exit the sleep mode, and an alert that the acceleration data corresponds to a collision. The alert can include a determination of a severity of the collision based on the acceleration data. In some implementations, the alert includes an estimate of where the collision occurred on the vehicle based on the acceleration data.

The mobile device 130 receives the acceleration data from the sensor device 120. In some implementations, the mobile device 130 retrieves the acceleration data from the sensor device 120. The mobile device 130 can execute a machine-learning model using as input the acceleration data to determine one or more events in the acceleration data to determine whether the acceleration data indicates a collision. The mobile device 130 can use as input the acceleration data and any determinations made by the sensor device 120 to determine whether the acceleration data indicates a collision. The mobile device 130 can transmit the acceleration data to the server 140 using a different communication protocol than used between the mobile device 130 and the sensor device 120. In an example, the mobile device 130 transmits the acceleration data to the server 140 via the Internet. In some implementations, the mobile device 130 transmits the acceleration data to the server 140 in response to determining that the acceleration data indicates a collision. In some implementations, the mobile device 130 adds data to the acceleration data regarding a position or condition of the vehicle. In an example, the mobile device 130 determines a geolocation of the mobile device 130 when the mobile device 130 reconnected with the sensor device 120 and adds the geolocation to the acceleration data as a location of the detected collision. In an example, the mobile device 130 determines a time of the acceleration data and adds the time to the acceleration data as a time of the detected collision.

The server 140 receives the acceleration data from the mobile device 130. The server 140 can execute a machine-learning model using as input the acceleration data to determine events within the acceleration data to determine whether the acceleration data indicates a collision occurred while the vehicle was parked 110. The server 140 can execute using as input the acceleration data, any determinations made by the sensor 120, and/or any determinations made by the mobile device 130. In some implementations, the server 140 executes a more powerful, more energy-intensive machine-learning model than is executed on the sensor device 120 or mobile device 130. In some implementations, the sensor device 120 executes a smallest, lowest-power machine-learning model, the mobile device 130 executes an intermediate-sized, intermediate-power machine-learning model, and the server 140 executes a largest, greatest-power machine-learning model to provide different levels of accuracy and/or precision in determining whether a collision occurred while the vehicle was parked. In some implementations, the server 140 receives the acceleration data in response to the sensor device 120 and/or the mobile device 130 determining that the acceleration data indicates that a collision occurred when the vehicle was parked.

The server 140, in response to determining that a collision occurred when the vehicle was parked, can transmit an alert to the mobile device 130 regarding the collision. The mobile device 130, in response to the alert from the server 140, the alert from the sensor device 120, and/or a determination made by the mobile device 130 that a collision occurred when the vehicle was parked, can generate a notification to a user of the mobile device 130 regarding the collision. The notification can include a prompt to record a status of the vehicle 110. In an example, the notification causes an application to open to capture photos and/or videos of the vehicle to upload to the server 140. In an example, the notification includes an estimate of where the collision occurred on the vehicle 110.

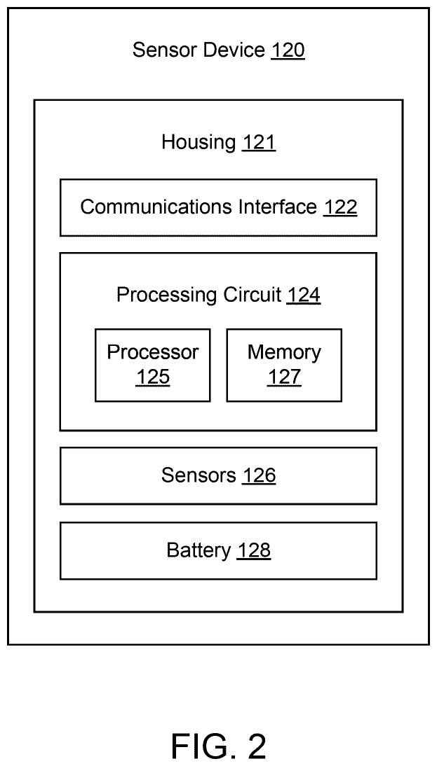

FIG. 2 illustrates details of the sensor device 120 of FIG. 1. The sensor device includes a housing 121. The housing 121 can be separate from and distinct from the vehicle 110. The housing 121 can be coupled to the vehicle to allow the sensor device 120 to capture acceleration data of the vehicle 110. The housing 121 encloses a communications interface 122, a processing circuit 124, sensors 126, and a battery 128.

The sensor device 120 can use the communications interface 122 to communicate with the mobile device 130, the vehicle sensor 112, the server 140, and other computing devices, such as a dashcam. The communications interface 122 can include one or more antenna for communicating using one or more communications protocols.

The processing circuit 124 receives sensor data from the sensors 126 to log and/or analyze the sensor data. The processing circuit 124 includes a processor 125 and a memory 127. The processor 125 can receive the sensor data from the sensors 126 and correlate the sensor data. In an example, the processor 125 receives time series acceleration data from three accelerometers capturing acceleration data along different axes and correlates the time series acceleration data into three-dimensional acceleration data. The processor 125 can log (i.e., store) the sensor data in the memory 127. The processor 125 can, as discussed herein, execute lower-power processes in a sleep mode and higher-power processes when not in the sleep mode. In this way, the sensor device 120 conserves power in the sleep mode.

The sensors 126 can include multiple different types of sensors including accelerometers, gyroscopes, barometers, sound sensors, and other sensors for capturing sensor data that can be used to determine whether a collision occurred while the vehicle was parked and/or for capturing sensor data that can be used to determine driving behavior while the vehicle is moving. In some implementations, a first subset of the sensors 126 capture data during the sleep mode and a second subset of the sensors 126 does not capture data during the sleep mode. In this way, the sensor device conserves power in the sleep mode.

The sensors 126, the processing circuit 124, and the communications interface 122 draw power from the batter 128. By drawing power from the battery 120, the sensor device 120 can operate independent of the vehicle 110 and a state of the vehicle 110, allowing the sensor device 120 to be coupled to any vehicle.

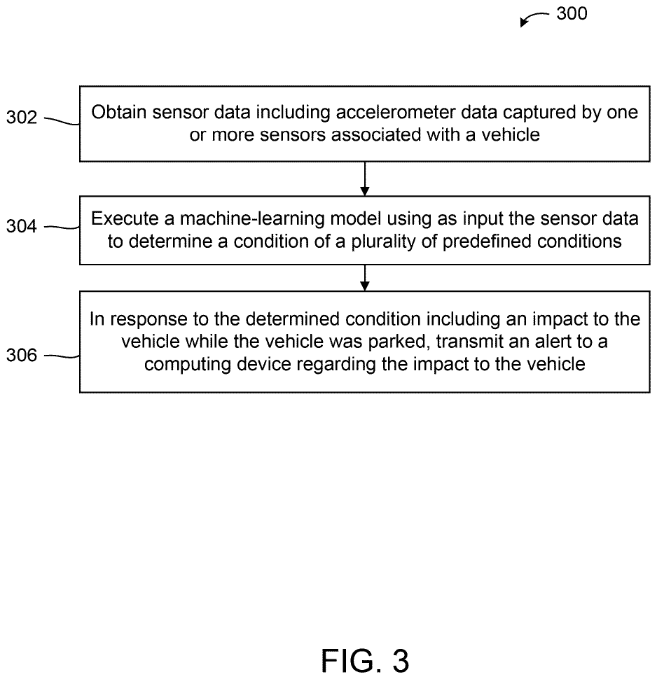

FIG. 3 is a flow chart illustrating operations of an example method for detecting parked vehicle collisions. The method 300 can include more, fewer, or different operations than shown. The operations can be performed in the order shown, in another order, or concurrently. The method 300 can be performed by one or more components in the environment 100 of FIG. 1, such as the sensor device 120, the mobile device 150, and/or the server 140. The method 300 can be performed by a computing device including one or more processors and one or more non-transitory, computer-readable media that, when executed by the one or more processors, cause the one or more processors to perform the operations of the method 300.

At operation 302, sensor data is obtained including accelerometer data captured by one or more sensors associated with a vehicle.

At operation 304, a machine-learning model is executed using as input the sensor data to determine a condition of a plurality of predefined conditions. In some implementations, the condition is a collision, or an impact to the vehicle while the vehicle is parked. In some implementations, the machine-learning model is executed using as input the sensor data to determine that the impact to the vehicle occurred and to determine a location of the impact to the vehicle. In an example, the machine-learning model takes as input the sensor data and outputs an indication that an impact occurred on a left-rear door of the vehicle.

At operation 306, in response to the determined condition including an impact to the vehicle while the vehicle was parked, an alert is transmitted to a computing device regarding the impact to the vehicle. In some implementations, the computing device, in response to the alert, executes a second machine-learning model to determine a second condition of the plurality of predefined conditions. The second condition can match, or agree with the determined condition in that both conditions include an impact to the vehicle. In this way, a greater level of confidence can be attained by correlation of the determinations of the two machine-learning models. In an example, the second machine-learning model is a more powerful machine-learning model that provides more accurate and/or precise determinations.

In some implementations, the computing device, in response to the alert, contacts a service provider regarding the impact. In an example, the computing device generates a notification with a trigger to initiate a phone call or text conversation with an insurance provider or mechanic. In some implementations, the computing device, in response to the alert, initiates a phone call or text conversation with a mobile device of a user associated with the vehicle. In an example, the computing device prompts the user to document a status of the vehicle and/or to submit an insurance claim for damage to the vehicle caused by the impact.

In some implementations, the method 300 is performed by a sensor device, such as the sensor device 120 of FIG. 1. The one or more sensors can include sensors of the sensor device coupled to and separate from the vehicle and/or sensors of other devices, such as dashcams. The sensor device can include accelerometers to capture the accelerometer data. The sensor device can include a housing enclosing the one or more sensors, the one or more processors, and the one or more non-transitory, computer-readable media including the instructions that when executed, cause the one or more processors to perform the operations of the method 300. The housing is separate from and coupled to the vehicle. In an example, the housing is attached to an interior surface of a windshield of the vehicle using adhesive. In some implementations, the sensor device determines, using the sensor data, that the sensor data exceeds one or more predefined thresholds (e.g., acceleration thresholds). The sensor device, in response to the sensor data exceeding the one or more predefined thresholds, can execute the machine-learning model using as input the sensor data. The sensor device can transmit the alert to a mobile device and/or a server, such as the mobile device 130 and the server 140 of FIG. 1. In some implementations, the sensor device transmits the alert to the mobile device and the alert triggers a notification to inspect a status of the vehicle. In an example, the notification on the mobile device prompts a user to inspect the vehicle for damage. In an example, the notification on the mobile device prompts a user to record image and/or video data of the vehicle.

In some implementations, the method 300 is performed by a mobile device, such as the mobile device 130 of FIG. 1. The mobile device can obtain the sensor data from a sensor device, such as the sensor device 120 of FIG. 2. The mobile device can execute the machine-learning model and transmit the alert to a server, such as the server 140 of FIG. 1. In response to the mobile device determining that an impact to the vehicle occurred while the vehicle was parked, the mobile device can generate a notification to document a condition of the vehicle (e.g., describe a condition of the vehicle, record image and/or video data of the vehicle). The mobile device can correlate the sensor data from the sensor device with geolocation data captured by the mobile device and include the geolocation data in the alert as a geolocation of the impact.

In some implementations, the method 300 is performed by a server, such as the server 140 of FIG. 1. In an example, the server receives the sensor data originating at a sensor device from a mobile device connected to the sensor device, executes the machine-learning model, and transmits the alert to the mobile device to cause a user of the mobile device to provide information regarding the status of the vehicle (e.g., text, images, video). The mobile device can upload the information regarding the status of the vehicle to the server for storage and/or analysis. In some implementations, the server updates the machine-learning model based on a difference between the determination of the impact to the vehicle and the status of the vehicle.

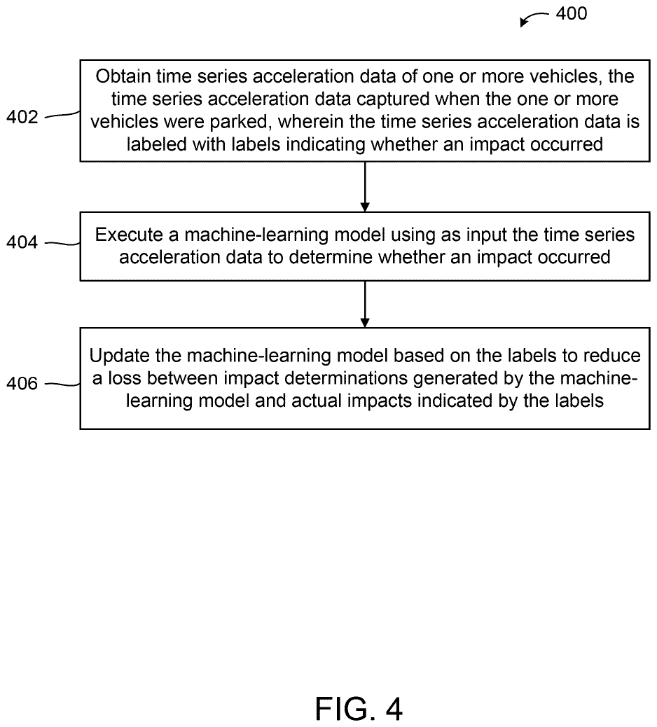

FIG. 4 is a flow chart illustrating operations of an example method for detecting parked vehicle collisions. The method 400 can include more, fewer, or different operations than shown. The operations can be performed in the order shown, in another order, or concurrently. The method 400 can be performed by one or more components in the environment 100 of FIG. 1, such as the sensor device 120, the mobile device 150, and/or the server 140. The method 400 can be performed by a computing device including one or more processors and one or more non-transitory, computer-readable media that, when executed by the one or more processors, cause the one or more processors to perform the operations of the method 400.

At operation 402, time series acceleration data of one or more vehicles is obtained, the time series acceleration data captured when the one or more vehicles were parked. The time series acceleration data is labeled with labels indicating whether an impact occurred. In some implementations, the labels indicate where an impact occurred on the vehicle (e.g., on which side, on which panel of the vehicle, etc.). In some implementations, the labels indicate a severity of the impact on the vehicle (e.g., amount of damage to the vehicle). In some implementations, the time series acceleration data is obtained for each of the one or more vehicles from a sensor device (e.g., the sensor device 120 of FIG. 1) that is separate from and coupled to the vehicle. In some implementations, the time series acceleration data includes historical time series acceleration data, where the labels are user input regarding impacts. In an example, the time series acceleration data includes acceleration data captured during a collision with a parked vehicle, and the label for the acceleration data is derived from a user report of the collision, such as an insurance claim.

At operation 404, a machine-learning model is executed using as input the time series acceleration data to determine whether an impact occurred. The time series data can include a plurality of instances, where each instance either includes or does not include an impact to the vehicle. The machine-learning model can be executed using as input each instance in the time series acceleration data to determine whether the instance includes an impact to the vehicle. In some implementations, the time series acceleration data includes a geolocation of the one or more vehicles. The machine-learning model can use as input the geolocation of the one or more vehicles. In an example, the machine-learning model can be trained to recognize that a vehicle on the side of the road or in a parking lot is more likely to suffer an impact while parked.

At operation 406, the machine-learning model is updated based on the labels to reduce a loss between impact determinations generated by the machine-learning model and actual impacts indicated by the labels. In this way, the machine-learning model may be updated using a supervised training process, where the weights and parameters of the machine-learning model are updated based on a loss between the impact determinations generated by the machine-learning model and actual impacts indicated by the labels. In some implementations, the machine-learning model is updated to reduce a difference between when the machine-learning model determines that an impact occurred and when the labels indicate that an impact occurred. In some implementations, the machine-learning model is updated to reduce a difference between where the machine-learning model determines that an impact occurred and where the labels indicate that the impact occurred. In some implementations, the machine-learning model is updated to reduce a difference between a severity of impact determined by the machine-learning model and a severity of impact indicated by the labels.

In some implementations, the method 400 includes training a preliminary machine-learning model. The preliminary machine-learning model can have a lower computational burden (e.g., smaller model, lower power draw, etc.) and a lower level of accuracy than the machine-learning model. The preliminary machine-learning model can be executed using as input the time series acceleration data to determine whether an impact occurred, a location of the impact, and/or a severity of the impact. The preliminary machine-learning model can be updated (e.g., weights and parameters of the preliminary machine-learning model) to reduce a loss between impact determinations generated by the preliminary machine-learning model and actual impacts indicated by the labels. In an example, the preliminary machine-learning model is configured to be executed by a sensor device or mobile device to generate preliminary determinations of impact occurrence, and the machine-learning model is configured to be executed by a server to determine final, or more accurate determinations of impact occurrence.

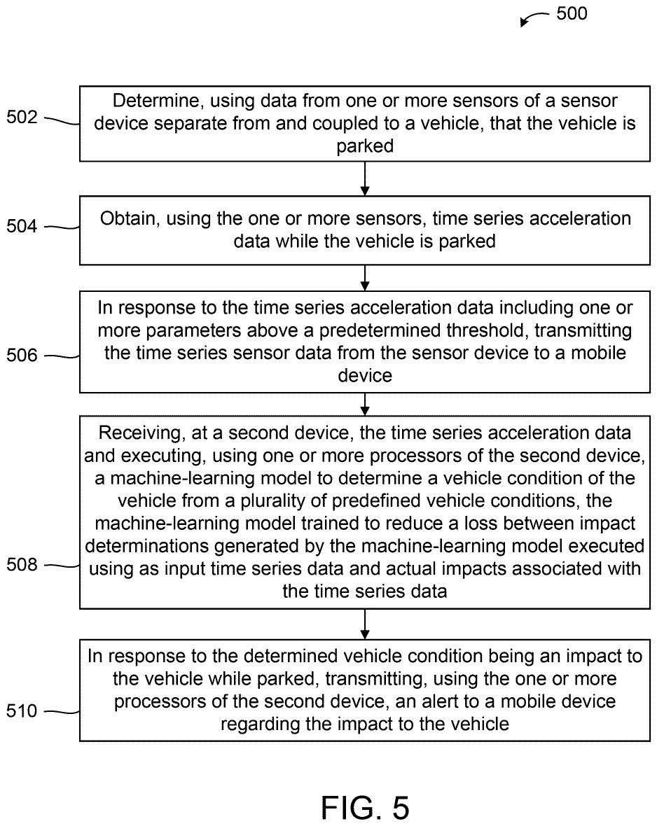

FIG. 5 is a flow chart illustrating operations of an example method 500 for detecting parked vehicle collisions. The method 500 can include more, fewer, or different operations than shown. The operations can be performed in the order shown, in another order, or concurrently. The method 500 can be performed by one or more components in the environment 100 of FIG. 1, such as the sensor device 120, the mobile device 150, and/or the server 140. The method 500 can be performed by a computing device including one or more processors and one or more non-transitory, computer-readable media that, when executed by the one or more processors, cause the one or more processors to perform the operations of the method 500.

At operation 502, a determination is made using data from one or more sensors of a sensor device separate from and coupled to a vehicle, that the vehicle is parked. In some implementations, the sensor device determines, using the data from the one or more sensors of the sensor device, that the vehicle is parked. The sensor device can enter a sleep mode within a predetermined time interval after the determination that the vehicle is parked. Determining that the vehicle is parked can be based on a combination of vehicle movement (or lack thereof) and loss of connection with another device, such as a mobile device or a vehicle computing system.

At operation 504, time series acceleration data is obtained while the vehicle is parked. The time series acceleration data can be captured by the sensor device in the sleep mode. The sleep mode can include execution of a lower-power process that conducts minimal analysis of the time series acceleration data (e.g., comparing the time series acceleration data to one or more predefined thresholds).

At operation 506, in response to the time series acceleration data including one or more parameters above a predetermined threshold, the time series sensor data is transmitted from the sensor device to a mobile device. The predetermined threshold can be defined to correspond to an intensity or amount of acceleration corresponding to a collision. The sensor device can exit the sleep mode based on the time series acceleration data including one or more parameters above a predetermined threshold. The sensor device can transmit the time series acceleration data to the mobile device in response to a connection being established between the sensor device and the mobile device. The sensor device can log the time series acceleration data (e.g., store in memory) for transmission to the mobile device once the connection is established.

At operation 508, the time series acceleration data is received at the second device and a machine-learning model is executed using one or more processors of the second device to determine a vehicle condition of the vehicle from a plurality of predefined vehicle conditions, the machine-learning model trained to reduce a loss between impact determinations generated by the machine-learning model executed using as input time series data and actual impacts associated with the time series data.

At operation 510, in response to the determined vehicle condition being an impact to the vehicle while parked, an alert is transmitted using the one or more processors of the second device to a mobile device regarding the impact to the vehicle.

In some implementations, the time series acceleration data is received at the mobile device from the sensor device and the mobile device transmits the time series acceleration data to the second device. The mobile device an execute a preliminary machine-learning model using as input the time series acceleration data to determine a preliminary vehicle condition from a plurality of preliminary vehicle conditions.

In some implementations, the method 500 includes, in response to the determined vehicle condition being an impact to the vehicle while parked, transmitting a request to an additional sensor device of the vehicle to store additional sensor data. The additional sensor device can be an integrated sensor of the vehicle (e.g., backup camera, rearview mirror cameras, etc.) or a device coupled to the vehicle (e.g., dashcam).

### Non-Limiting Example

In an example, a sensor device is attached on an interior surface of a windshield of a vehicle. The sensor device can connect to a mobile device of a driver of the vehicle to transmit acceleration data to the mobile device using a wireless protocol, such as Bluetooth. When the sensor device is not connected to the mobile device, the sensor device is asleep, running a lower-energy process that monitors acceleration data to determine whether an acceleration of the sensor device (and thus the vehicle) exceeds a predetermined threshold. In response to the acceleration of the sensor device exceeding the predetermined threshold, the sensor device wakes up by starting a higher-energy process to log acceleration data and logs an alert that a collision may have occurred. When the mobile device reconnects to the sensor device via the wireless protocol, the sensor device transmits the logged acceleration data and the alert to the mobile device. The mobile device transmits, using a second wireless protocol, the logged acceleration data to a server, which executes a machine-learning model to determine whether the logged acceleration data indicates that a collision occurred. In response to determining that the logged acceleration data indicates that a collision occurred, the server transmits an indication of the potential collision to the mobile device, causing the mobile device to display a notification that a collision may have occurred and that a user of the mobile device should inspect the vehicle for damage. A user, in response to the notification, records images and/or video of the vehicle and uploads the recorded images and/or video to the server to document a status of the vehicle. Thus, although the user was not present to see the collision, and no vehicle systems detected the collision, the sensor device detected the collision and the user was alerted such that the vehicle status was documented before the user drove away.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In some embodiments, a computer program is provided, and the program is embodied on a computer readable medium. In some embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions can be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A system, comprising:
one or more processors; and
one or more non-transitory, computer-readable media including instructions which, when executed by the one or more processors, cause the one or more processors to:
obtain sensor data including accelerometer data captured by one or more sensors associated with a vehicle;
execute a machine-learning model using as input the sensor data to determine a condition of a plurality of predefined conditions; and
in response to the determined condition including an impact to the vehicle while the vehicle was parked, transmit an alert to a computing device regarding the impact to the vehicle.

2. The system of claim 1, further comprising a housing enclosing the one or more sensors, the one or more processors, and the one or more non-transitory, computer-readable media, wherein the housing is separate from and coupled to the vehicle.

3. The system of claim 2, wherein the instructions cause the one or more processors to:
determine, using the sensor data, that the sensor data exceeds one or more predefined thresholds; and
in response to the sensor data exceeding the one or more predefined thresholds, executing the machine-learning model using as input the sensor data.

4. The system of claim 2, wherein the computing device comprises a mobile device, and wherein the alert triggers a notification to inspect a status of the vehicle.

5. The system of claim 1, wherein the instructions cause the one or more processors to obtain the sensor data from a sensor device coupled to the vehicle.

6. The system of claim 5, wherein the instructions cause the one or more processors to generate a notification to document a condition of the vehicle.

7. The system of claim 5, wherein the instructions cause the one or more processors to correlate the sensor data with geolocation data.

8. The system of claim 1, wherein the instructions cause the one or more processors to execute the machine-learning model using as input the sensor data to determine a location of the impact to the vehicle.

9. The system of claim 1, wherein the computing device executes a second machine-learning model to determine a second condition of the plurality of predefined conditions.

10. The system of claim 1, wherein the alert includes a request to store camera data.

11. The system of claim 10, wherein the computing device comprises a camera coupled to the vehicle.

12. One or more non-transitory, computer-readable media including instructions which, when executed by one or more processors, cause the one or more processors to:
obtain time series acceleration data of one or more vehicles, the time series acceleration data captured when the one or more vehicles were parked, wherein the time series acceleration data is labeled with labels indicating whether an impact occurred;
execute a machine-learning model using as input the time series acceleration data to determine whether an impact occurred; and
update the machine-learning model based on the labels to reduce a loss between impact determinations generated by the machine-learning model and actual impacts indicated by the labels.

13. The one or more non-transitory, computer-readable media of claim 12, wherein the instructions cause the one or more processors to obtain the time series acceleration data of each of the one or more vehicles from a sensor device that is separate from and coupled to the vehicle.

14. The one or more non-transitory, computer-readable media of claim 12, wherein the time series acceleration data comprises historical time series acceleration data, and wherein the labels comprise user input regarding impacts.

15. The one or more non-transitory, computer-readable media of claim 12, wherein the time series acceleration data includes a geolocation of the one or more vehicles.

16. The one or more non-transitory, computer-readable media of claim 12, wherein the labels indicate a location of impact on the vehicle, and where the instructions cause the one or more processors to update the machine-learning model based on the labels to reduce a loss between impact location determinations generated by the machine-learning model and actual impact locations indicated by the labels.

17. The one or more non-transitory, computer-readable media of claim 12, wherein the instructions cause the one or more processors to update a preliminary machine-learning model based on the labels to reduce a loss between impact determinations generated by the preliminary machine-learning model and actual impacts indicated by the labels, wherein the preliminary machine-learning model has a lower level of accuracy than the machine-learning model, and wherein the preliminary machine-learning model has a lower computational burden than the machine-learning model.

18. A method, comprising:
determining, using data from one or more sensors of a sensor device separate from and coupled to a vehicle, that the vehicle is parked;
obtaining, using the one or more sensors, time series acceleration data while the vehicle is parked;
in response to the time series acceleration data including one or more parameters above a predetermined threshold, transmitting the time series acceleration data from the sensor device to a mobile device;
receiving, at a second device, the time series sensor data;
executing, using one or more processors of the second device, a machine-learning model to determine a vehicle condition of the vehicle from a plurality of predefined vehicle conditions, the machine-learning model trained to reduce a loss between impact determinations generated by the machine-learning model executed using as input time series data and actual impacts associated with the time series data; and
in response to the determined vehicle condition being an impact to the vehicle while parked, transmitting, using the one or more processors of the second device, an alert to a mobile device regarding the impact to the vehicle.

19. The method of claim 18, further comprising executing, at the mobile device, a preliminary machine-learning model to determine a preliminary vehicle condition from a plurality of preliminary vehicle conditions.

20. The method of claim 18, further comprising, in response to the determined vehicle condition being an impact to the vehicle while parked, transmitting a request to an additional sensor device of the vehicle to store additional sensor data.
